(19) United States
(12) Patent Application Publication
(10) Pub. No.: US 2026/0003468 A1
(43) Pub. Date: Jan. 1, 2026

(54) BIO-IMPEDANCE SENSING FOR GESTURE INPUT, OBJECT RECOGNITION, INTERACTION WITH PASSIVE USER INTERFACES, AND/OR USER IDENTIFICATION AND/OR AUTHENTICATION

(71) Applicant: University of Washington, Seattle, WA (US)

(72) Inventors: Anandghan Waghmare, Seattle, WA (US); Youssef Ben Taleb, Seattle, WA (US); Arjun Narendra, Seattle, WA (US); Shwetak N Patel, Seattle, WA (US)

(21) Appl. No.: 18/877,931

(22) PCT Filed: Mar. 22, 2023
(86) PCT No.: PCT/US2023/015954

§ 371 Date: Dec. 20, 2024

Related U.S. Application Data
(60) Provisional application No. 63/359,137, filed on Jul. 7, 2022.

(51) Int. Cl. G06F 3/046; G06F 3/01; G06F 21/32

(52) U.S. Cl. CPC G06F 3/046; G06F 3/017; G06F 21/32

(57) ABSTRACT

This disclosure describes systems, apparatuses, and methods that utilize electric field sensing in an antenna topology. In some embodiments, the systems, apparatuses, and methods use a sensing modality, such as bio-impedance sensing, to detect and/or determine one or more user activities. The bio-impedance sensing can be used for held-object or touched-object recognition, gesture input recognition (e.g., recognition of one-handed gestures, two-handed gestures, etc.), user interface (UI) interaction by utilizing electrically passive components, and/or biometric identification and/or authentication.

### CROSS-REFERENCE TO RELATED APPLICATIONS

This application claims the benefit under 35 U.S.C. § 119(e) of the earlier filing date of U.S. Provisional Application No. 63/359,137 filed Jul. 7, 2022, the entire contents of which are hereby incorporated by reference in their entirety for any purpose.

### BACKGROUND

A human body, an animal's body, portions thereof, flesh, and tissue are lossy conductors of high-frequency electric fields, allowing the body to act as a transmission medium for alternating current (AC) signals or as a shunt to ground. This property has been employed for human-computer interaction for proximity, touch, communication, identification, medical imaging, and motion sensing applications.

In some systems, a pair (two) of electrodes that are used to transmit and receive AC signals can be embedded in or on a wearable electronic device on a body or a portion thereof (e.g., hand, finger, head, wrist, leg, etc.). In configurations that utilize a shunt or a mutual capacitance mode, a proximity of the body (or the portion thereof) to the two of electrodes modifies the mutual capacitance between the two electrodes. These configurations can be used in touch screens and trackpads.

In some systems, when utilizing a self-capacitance mode, the same electrode, which may be embedded in or on an electronic device (e.g., a wearable electronic device), the electronic device can be configured to transmit and receive AC signals. When utilizing the self-capacitance mode of the electronic device, as a ground-coupled body (or portion thereof) moves closer to the electrode, some of the field is directed through the body, thereby, modifying the capacitance or the self-capacitance of the electrode.

In some systems, the body can be utilized as a transmitter, or the body can be appropriated as a transmitting antenna, when the user uses an electronic device. For example, a user can hold a car fob (i.e., an electronic device) near their forehead in order to extend the signal transmission range of the car fob, for example, when the user is searching for their car in a crowded parking lot.

In some systems, the body can act or be utilized as a receiver, when the user uses an electronic device. For example, an electronic device can be configured to perform user identification via touch interactions. This configuration may use a first object as a transmitter, while using the body and a second object as a receiver. As another example, an electronic device can use the body as a receiver to identify touches on a touchscreen. As another example, for touched-based object interaction, an electronic device can use an electrode on the rear of the neck of a user to measure changes in ambient radio frequency (RF) signals (e.g., due to wiring of a building, appliances, switches, etc.) as the user touches appliances, light switches, and walls. As yet another example, an electronic device can use a radio and a wire coil, respectively, to capture broadband electromagnetic noise that is generated by electrically active household objects.

In some systems, the body can be configured to act or be utilized as a waveguide, when the user uses an electronic device. A body-as-waveguide (or an intrabody coupling) configuration combines both transmit and receive topologies with the body in direct galvanic contact with both electrodes. For example, the body-as-waveguide configuration has been investigated for intrabody and interbody communication networks and in the medical context to non-invasively examine the body's internal make up and tissue properties. As another example, intrabody coupling methods have also been leveraged for gesture applications, for example, by using multiple electrodes to classify gestures.

In some systems, the body can be configured to act or be utilized as a reflector, as the user uses an electronic device. In a body-as-reflector configuration, RF electromagnetic waves generated by the electronic device reflect off sharp changes in impedance, such as when they encounter the boundary between air and a body. For example, Doppler radar may use this phenomenon to measure spatial changes, including subtle changes, such as changes associated with thumb-to-finger micro-gestures.

### BRIEF SUMMARY

Example electronic devices are disclosed herein. In an embodiment of the disclosure, an electronic device comprising includes reflection coefficient measurement circuitry. The electronic device may also include a signal trace that is configured (or is configurable) to be coupled between the reflection coefficient measurement circuitry and a portion of a body. The reflection coefficient measurement circuitry is configured to: transmit electromagnetic waves into said portion of the body using said signal trace and measure a reflection coefficient over a range of frequencies of said electromagnetic waves. The electronic device may also include a processor. Based on the reflection coefficient, the processor is configured (or is configurable) to determine a position of the portion of the body, a motion of the portion of the body, a touch of an exterior object with the portion of the body, or combinations thereof.

Additionally, or alternatively, the signal trace is configured to carry a transmitted signal from the reflection coefficient measurement circuitry to the portion of the body, and a reflected signal from the portion of the body to the reflection coefficient measurement circuitry.

Additionally, or alternatively, the electronic device may include a biasing circuit for biasing said portion of the body.

Additionally, or alternatively, the biasing circuit may include a biasing resistor that may be coupled between a biasing trace and ground. The biasing trace may be configured to be coupled to the portion of the body.

Additionally, or alternatively, the position and the motion cause a geometrical change of the portion of the body, and the geometrical change causes an impedance change of the portion of the body.

Additionally, or alternatively, the reflection coefficient measurement circuitry may be or may include a vector network analyzer (VNA). The VNA is configured to measure at least one scattering parameter (S-parameter).

Additionally, or alternatively, the S-parameter may be an S11 parameter, and the signal trace may be coupled with the portion of the body at a contact point.

Additionally, or alternatively, the range of frequencies may include frequencies between one megahertz (MHz) and one gigahertz (GHz), 50 kilohertz (kHz) and six GHz, or another range of frequencies.

Additionally, or alternatively, the signal trace may be embedded in or on a ring, a glove, a wristband, a headband, or a headset.

Additionally, or alternatively, the processor is further configured to utilize a machine learning model. The machine learning model may be configured to identify a gesture of a user, a passive interface input, an exterior object, a user identification or authentication, or combinations thereof.

Example methods for identifying or authenticating a user are described herein. In an embodiment of the disclosure the method may include transmitting, via a signal trace, electromagnetic waves into a portion of a body of the user. The method may also include measuring, using a reflection coefficient measurement circuitry, a reflection coefficient over a range of frequencies of the electromagnetic waves. The method may also include measuring an absorption pattern of the electromagnetic waves by the body or the portion of the body of the user. The method may also include identifying or authenticating the user based on a unique or a nearly unique absorption pattern of the electromagnetic waves.

Additionally, or alternatively, the identification of the user includes identifying the user, using a machine learning model, as an authorized user or as an unauthorized user of a user device, an application, a function, or a peripheral thereof.

Additionally, or alternatively, the method may also include granting access to the authorized user to utilize the user device, the application, the function, or the peripheral thereof. The method may also include denying access to the unauthorized user from utilizing the user device, the application, the function, or the peripheral thereof.

Additionally, or alternatively, the user may be an authorized user of a plurality of authorized users of the user device, the application, the function, or the peripheral thereof, and the identification or the authentication may include differentiating or recognizing identities between the plurality of authorized users.

Additionally, or alternatively, the user utilizes an electronic device with the signal trace and the reflection coefficient measurement circuitry, and the identification or the authentication may include a continuous or time interval identification or authentication of the user.

Additionally, or alternatively, the electronic device may be or may be embedded in or on a wearable electronic device. Additionally, or alternatively, the continuous or time interval identification or authentication may be a first-factor authentication of a plurality-factor authentications.

Additionally, or alternatively, the method may also include measuring an absorption pattern of the electromagnetic waves due to a position of the portion of the body, a motion of the portion of the body, a touch of an exterior object with the portion of the body, a touch of a passive interface with the portion of the body, or combinations thereof.

Example interface systems of a user device are described herein. In an embodiment, the system may include a processor, reflection coefficient measurement circuitry, a signal trace, one or more electrically passive user interfaces, and a computer-readable storage medium. The signal trace may be coupled, or may be configured to be coupled, between the reflection coefficient measurement circuitry and a portion of a body of a user. The electrically passive user interfaces may be or may constructed using one or more electrically-conductive materials. The computer-readable storage medium includes instructions that when executed by said processor, cause said processor to: transmit electromagnetic waves from the reflection coefficient measurement circuitry to a portion of a body of the user via the signal trace; measure a reflection coefficient of the electromagnetic waves using the reflection coefficient measurement circuitry; and identify a user touch of one or more electrically passive user interfaces based on the reflection coefficient.

Additionally, or alternatively, the electrically passive user interfaces may be or may include one or more buttons, one or more sliders, one or more trackpads, or combinations thereof.

Additionally, or alternatively, the identification of the user touch causes an action of a plurality of pre-determined actions supported by the user device, an application, a function, or a peripheral thereof.

### BRIEF DESCRIPTION OF THE DRAWINGS

FIG. 1 is a block diagram showing electrical and/or communication couplings between a body or a portion thereof of a user, an electronic device, a passive user interface, and a user device, in accordance with examples described herein.

FIG. 2 shows a biasing circuit and a signal trace embedded in or on a ring, in accordance with examples described herein.

FIG. 3 is an electrical model of one or portions of FIG. 1 and/or one or more potions of FIG. 2, in accordance with examples described herein.

FIG. 4A shows a hand of a user wearing the ring, and the user is holding an object, in accordance with examples described herein.

FIG. 4B shows the hand of the user wearing the ring, and the user is performing a one-handed gesture, in accordance with examples described herein.

FIG. 4C shows the hand of the user wearing the ring, and the user is touching the passive user interface, in accordance with examples described herein.

FIG. 5 shows an electrical path, where the user wearing the ring of FIG. 2 performs the one-handed gesture, in accordance with examples described herein.

FIG. 6 shows another electrical path, where the user wearing the ring of FIG. 2 performs a two-handed gesture, in accordance with examples described herein.

FIG. 7 shows aspects of various one-handed gestures, in accordance with examples described herein.

FIG. 8 shows aspects of various two-handed gestures, in accordance with examples described herein.

FIG. 9 shows various passive user interfaces, in accordance with examples described herein.

FIG. 10 shows a graph of reflection coefficients as the user touches or holds various objects, where the reflection coefficients are measured over a range of frequencies, in accordance with examples described herein.

### DETAILED DESCRIPTION

Certain details are set forth herein to provide an understanding of described embodiments of technology. However, other examples may be practiced without various of these particular details. In some instances, well-known circuits, control signals, timing protocols, machine learning techniques and/or software operations have not been shown in detail in order to avoid unnecessarily obscuring the described embodiments. Other embodiments may be utilized, and other changes may be made, without departing from the spirit or scope of the subject matter presented here.

Our hands can provide a window into our intentions, context, and/or activities. As the body's primary manipulator, the hand engages in a wide variety of tasks, such as grasping objects, gesturing to signal intention, and operating interactive controls. Wearable sensing can elucidate these interactions, for example, by providing context or input to enable richer and more powerful computational experiences for gaming, augmented and virtual reality (AR/VR), ubiquitous computing, or other activities.

This disclosure describes systems, apparatuses (e.g., an electronic device), and methods that utilize electric field sensing in an antenna topology. In some embodiments, the systems, apparatuses, and methods use a sensing modality, such as bio-impedance sensing, to detect one or more user activities. The bio-impedance sensing can be used for held-object or touched-object recognition, gesture input recognition (e.g., recognition of one-handed gestures, two-handed gestures, etc.), user interface (UI) interaction by utilizing electrically-passive components (e.g., passive user interface(s), passive UI(s)), and/or biometric identification and/or authentication.

As the body or a portion thereof (e.g., a hand, a finger, a wrist, the neck, the head) of a user assumes different poses, grasps objects, or touches conductive surfaces, the electromagnetic properties of an antenna system change. These changes can be quantified by the electronic device, which is configurable to measure a bio-impedance (sometimes denoted by “Z”) of the body or a portion thereof of a user of the electronic device.

In some embodiment, a user can utilize the electronic device (e.g., a wearable electronic device) that is configured to detect, determine, and/or decipher, for example, touches and finger movements. To that end, the electronic device can detect, determine, and/or decipher micro-gesture inputs of the user. Since electromagnetic waves (e.g., RF wave, RF signals, electrical signals) from the electronic device can travel through the body or a portion thereof (e.g., the hand, the finger) to external objects or surfaces contacted by the hand or the finger, the electronic device can detect variations in the hand's impedance profile that are caused by external interactions. By so doing, the electronic device can be used to recognize objects that are touched by, for example, the hand of the user.

In some embodiments, the user can utilize the electronic device in conjunction with a passive user interface(s). The passive user interface(s) 124 may include one or more electrically passive (e.g., un-powered), but electrically conductive (e.g., metal, copper, aluminum, steel, etc.) or slightly electrically conductive (e.g., material with aqueous content), buttons, one-dimensional (1D) sliders, two-dimensional (2D) trackpads, or other passive user interface(s) having other geometries.

In some embodiments, the electronic device can identify or authenticate the user. For example, in cases when the electronic device is a wearable electronic device or operates in conjunction with a wearable device, as the user simply wears the wearable electronic device or the wearable device, the electronic device can identify or authenticate the user due to the distinct anatomical variations of the human body, which produce a distinct frequency signature response.

Some existing systems and apparatuses configure an object (e.g., a door knob) to be utilized as an antenna or require a user to wrap the hand around a device with an embedded antenna. By contrast, the systems, the apparatuses (e.g., the electronic device), and methods described herein may use the hand itself as an antenna (e.g., a duplex antenna). In some embodiments, the electronic device described herein can be embedded on a wearable device, which can increase the count of possible applications. Therefore, the electronic device can be used for held-object or touched-object recognition, gesture input recognition, user interactions using passive user interface(s), and/or biometric identification and/or authentication. Examples of wearable devices include a ring, a glove, a wristband, a headband, a headset, or another type of wearable device that uses the electronic device described herein.

Some existing systems that utilize a body-as-antenna configuration rely on ambient RF signals for operation, thereby, limiting their operation to a specific location. Some existing (e.g., prior art) systems may rely on RF emission from devices for object detection, thereby, limiting their use to electrically active objects. By contrast, the systems, apparatuses, and methods described herein use an active impedance sensing approach, thereby, they can be used anywhere (or nearly anywhere), with passive user interface(s), and/or with passive external objects.

The systems, apparatuses, and methods described herein may use a broad range(s) of frequencies for sensing, such as a range of frequencies between one megahertz (MHz) and one gigahertz (GHz), 50 kilohertz (kHz) and six GHz, or another range of frequencies. The broad range(s) of frequencies may provide a rich, or richer, set of sensing capabilities compared to systems that use discrete frequency impedance sensing. It is to be understood, however, that even though the system, apparatuses, and methods described herein are configurable to use broad range(s) of frequencies, they may in other examples use discrete frequencies, should a user or a manufacturer desire to do so.

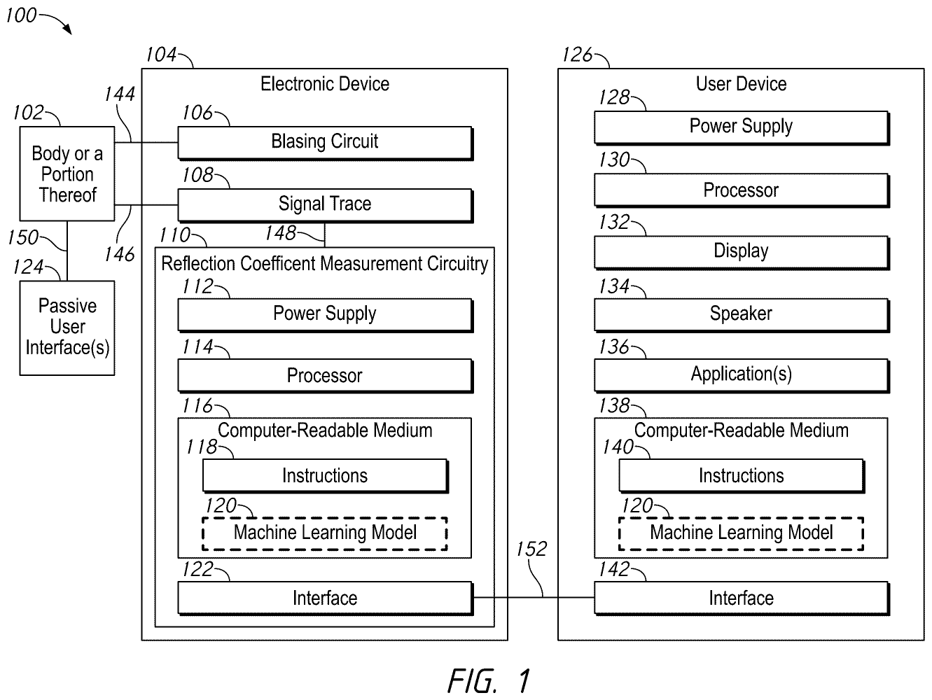

FIG. 1 is block diagram 100 showing electrical and/or communication coupling(s) between a body or a portion thereof 102 of a user, an electronic device 104, a passive user interface(s) 124, and a user device 126, in accordance with examples described herein.

In some embodiments, the electronic device 104 may include a biasing circuit 106, a signal trace 108, a reflection coefficient measurement circuitry 110, a power supply 112, a processor 114, a computer-readable medium 116, instructions 118, machine learning model 120, and an interface 122. Nevertheless, the electronic device 104 may include additional or fewer components than what is illustrated in FIG. 1.

In some embodiments, the user device 126 may include a power supply 128, a processor 130, a display 132, a speaker 134, an application(s) 136, a computer-readable medium 138, machine learning model 120, and an interface 142. Nevertheless, the user device 126 may include additional of fewer components than what is illustrated in FIG. 1.

In some embodiments, the biasing circuit 106 is electrically coupled to the body or a portion thereof 102 via a coupling or contact 144; the signal trace 108 is electrically coupled to the body or a portion thereof 102 via a coupling or contact 146; and the signal trace 108 is electrically coupled to the reflection coefficient measurement circuitry 110 via a coupling or transmission line 148. In some embodiments, the user may use the body or a portion thereof 102 to touch the passive user interface(s) 124 via a touch 150. In some embodiments, the interface 122 of the electronic device 104 communicates with the interface 142 of the user device 126 using a communication coupling 152.

The body or a portion thereof 102 may include human or non-human flesh or tissue (e.g., flesh or tissue of a creature in the kingdom Animalia). For example, depending on specific configuration or applications, the body or a portion thereof 102 can be the whole body, at least one finger, at least one wrist, at least one arm, the neck, the head, or another portion of a person (e.g., user, human). As another example, the body or a portion thereof 102 can be the whole body, a leg, the neck, the tail, or another anatomical part of a household pet, another domesticated animal, or a non-domesticated animal.

The electronic device 104 may be a stationary or a mobile electronic device; a wearable or a non-wearable electronic device; a small-sized, a medium-sized, or a large-sized electronic device; and/or a mass-produced electronic device or a custom-built electronic device.

In some embodiments, for example, as is illustrated in FIG. 1, the electronic device 104 includes the biasing circuit 106 and the signal trace 108 that are outside and/or separate physical entities from the reflection coefficient measurement circuitry 110. For example, the biasing circuit 106 and the signal trace 108 may be embedded in or on a ring (a first wearable electronic device or a first electronic device), while the electronic device 104 may be embedded in or on a wristband (a second wearable electronic device or a second electronic device). In other embodiments, however, all the components of the electronic device 104 can be integrated into one electronic device or into one wearable electronic device.

Similarly, in some embodiments, the reflection coefficient measurement circuitry 110 includes the power supply 112, the processor 114, the computer-readable medium 116 having the instructions 118 and the machine learning model 120, and the interface 122. In other embodiments, however, one or more of the components of the reflection coefficient measurement circuitry 110 may be a separate physical entity from the reflection coefficient measurement circuitry 110, but still be electrically and/or communicationally coupled to the reflection coefficient measurement circuitry 110. For example, although not illustrated as such, the power supply 112 may be a separate power supply that can power the reflection coefficient measurement circuitry 110 or a component thereof, and/or the reflection coefficient measurement circuitry 110 or a component thereof.

In some embodiments, the reflection coefficient measurement circuitry 110 may be implemented using a vector network analyzer (VNA) configured to measure at least one scattering parameter (S-parameter). The count and type of S-parameters depend on the complexity of the reflection coefficient measurement circuitry 110 (e.g., the VNA). For example, the reflection coefficient measurement circuitry 110 can be a 1-port, a 2-port, or a 4-port VNA, depending on the specific applications. For the sake of clarity, for a 2-port VNA, the S-parameters may and include an S11 parameter, an S12 parameter, an S21 parameter, and an S22 parameter. These S-parameters may generally be described as: the S11 parameter is the input port voltage reflection coefficient; the S12 parameter is the reverse voltage gain; the S21 parameter is the forward voltage gain; and the S22 parameter is the output port voltage reflection coefficient.

In some embodiments, it may be advantageous to utilize the S11 parameter, because the S11 parameter may utilize only one point of contact of body or a portion thereof 102. For example, the signal trace 108 and/or the biasing circuit 106 may contact only one finger, one hand, the head, etc.

To utilize the S21 parameter, the electronic device 104 may utilize additional points of contact. For example, the signal trace 108 and/or the biasing circuit 106 may make contact with a first finger or a first hand, and another signal trace (not illustrated in FIG. 1) and/or another biasing circuit (not illustrated in FIG. 1) may make contact with a second finger or a second hand. Therefore, the electronic device 104 can be modified to measure multiple S-parameters.

FIG. 1 illustrates the electronic device 104 being a separate physical entity from the user device 126. Alternatively (not illustrated as such in FIG. 1), the electronic device 104 and the user device 126 can be integrated into one device.

Examples of the user device 126 include a smartphone, a tablet, a laptop, a desktop computer, a smartwatch, computing or smart eyeglasses, a VR/AR headset, a gaming system or controller, a smart speaker system, a television, an entertainment system, an automobile or a function thereof, a trackpad, a drawing pad, a netbook, an e-reader, a home security system, a smart weapon, a smart vault, a doorbell, an appliance, and other user devices.

The power supply 112 of the reflection coefficient measurement circuitry 110 (and/or the electronic device 104) may be equivalent to, or different from, the power supply 128 of the user device 126. As described herein, the power supply 112 and the power supply 128 can be a variety of power supplies capable of powering the reflection coefficient measurement circuitry 110 (or components thereof) and the user device 126 (or components thereof), respectively. For example, either or both of the power supply 112 and the power supply 128 may draw power from an external power source (e.g., a single-phase 120 Volt (V)-60 Hertz (Hz) outlet) through a power adapter (not illustrated as such in FIG. 1). As another example, either or both of the power supply 112 and power supply 128 may include a battery (e.g., a rechargeable battery).

The processor 114 of the reflection coefficient measurement circuitry 110 (and/or the electronic device 104) may be implemented using, or may be different from, the processor 130 of the user device 126. In some embodiments, the processor 114 and the processor 130 may be substantially any electronic circuitry or component that may be capable of processing, receiving, and/or transmitting instructions (e.g., the instructions 118, the instructions 140) and/or the machine learning model 120. In aspects, either or both of the processor 114 and the processor 130 may be implemented using one or more processors (e.g., a central processing unit (CPU), a graphic processing unit (GPU)), and/or other circuitry, where the other circuitry may include one or more of an application specific integrated circuit (ASIC), a field programmable gate array (FPGA), a microprocessor, a microcomputer, and/or the like. In some embodiments, either or both of the processor 114 and the processor 130 may be configured to execute the instructions 118 and/or the instructions 140, respectively, serially, in parallel, locally, across the reflection coefficient measurement circuitry 110 and the user device 126 using the communication coupling 152, and/or across a network, for example, by using cloud and/or server computing resources.

The computer-readable medium 116 of the reflection coefficient measurement circuitry 110 may be equivalent to, or different from, the computer-readable medium 138 of the user device 126. In some embodiments, either or both of the computer-readable medium 116 and computer-readable medium 138 illustrated in FIG. 1 may be and/or include any suitable data storage media, such as volatile memory and/or non-volatile memory. Examples of volatile memory may include a random-access memory (RAM), such as a static RAM (SRAM), a dynamic RAM (DRAM), or a combination thereof. Examples of non-volatile memory may include a read-only memory (ROM), a flash memory (e.g., NAND flash memory, NOR flash memory), a magnetic storage medium, an optical medium, a ferroelectric RAM (FeRAM), a resistive RAM (RRAM), and so forth.

As is illustrated in FIG. 1, the computer-readable medium 116 of the reflection coefficient measurement circuitry 110 includes, permanently stores, or temporarily stores the instructions 118; and the computer-readable medium 138 of the user device 126 includes, permanently stores, or temporarily stores the instructions 140. Either or both of the instructions 118 and the instructions 140 may include code, pseudo-code, algorithms, software modules and/or so forth and are executable by a processor.

The systems, apparatuses, and methods described herein utilize the machine learning model 120. The machine learning model 120 may be temporarily or permanently stored and/or trained in the computer-readable medium 116 of the reflection coefficient measurement circuitry 110 (and/or the electronic device 104), the computer-readable medium 138 of the user device 126, or on a server (not illustrated in FIG. 1). The machine learning model 120 may be programmed using a variety of programming languages, such as Python and/or a package thereof (e.g., sklearn, TensorFlow). The machine learning model 120 may be, and/or the training of the machine learning model 120 may be accomplished using, a neural network, a support vector machine, a recurrent neural network (RNN), a convolutional neural network (CNN), a dense neural network (DNN), a support vector machine (SVM) classifier, a random forest regressor, a random forest classifier, heuristics, another type of a machine learning model, or combinations thereof. The training of the machine learning model 120 can be done using computational resources of the reflection coefficient measurement circuitry 110 (and/or the electronic device 104), the user device 126, or a server (not illustrated in FIG. 1).

In some embodiments, for user identification or authentication, the machine learning model 120 may include or use a random forest classifier (e.g., number of trees=50, maximum depth=30). The S11 measurements are inputs to the machine learning model 120 (or the random forest classifier), and the identity of the user is an output of the machine learning model 120 (or the random forest classifier).

In some embodiments, the machine learning model 120 may not require user input during training, because the machine learning model 120 may already be pre-trained and ready to be used by the user. In such a case, the machine learning model 120 may be a user-independent model. For example, the machine learning model 120 may already be trained for gesture input recognition. As another example, the machine learning model 120 may already be trained for the passive user interface(s) 124.

In other embodiments, the machine learning model 120 may require little or some user input during training, because the machine learning model 120 may be already pre-trained but may require some user input to increase the accuracy of the machine learning model 120. For example, the machine learning model 120 may be pre-trained to recognize some external objects, but the user may train to the machine learning model 120 to recognize other external objects that they encounter in their life.

In yet other embodiments, the machine learning model 120 requires a user input during training. In such a case, the machine learning model 120 may be a user-dependent model. For example, the machine learning model 120 is user-dependent to perform user identification or authentication.

Generally, the machine learning model 120 or a component thereof (e.g., an SVM classifier) can differentiate whether the user is holding an object, using a passive user interface(s) 124, performing a pre-defined one-handed gesture, performing a pre-defined two-handed gesture, standing still, or performing an unrelated activity (everyday activities). Therefore, the machine learning model 120 includes user intent classification.

In some embodiments, the display 132 may display visual information, such as an image(s), a video(s), a graphical user interface (GUI), notifications, instructions, text, and so forth. The display 132 may aid the user in interacting with the user device 126, the electronic device 104, and/or the passive user interface(s) 124. In some embodiments, the display 132 may display images and/or instructions requesting user input (e.g., via a GUI) during the training of the machine learning model 120. In some embodiments, the display 132 may utilize a variety of display technologies, such as a liquid-crystal display (LCD) technology, a light-emitting diode (LED) backlit LCD technology, a thin-film transistor (TFT) LCD technology, an LED display technology, an organic LED (OLED) display technology, an active-matrix OLED (AMOLED) display technology, a super AMOLED display technology, and so forth. In some embodiments, if the user device 126 is an AR/VR headset, the display 132 may also include a transparent or semi-transparent element, such as a lens or waveguide, that allows the user to simultaneously see a real environment and information or objects projected or displayed on the transparent or semi-transparent element, such as virtual objects in a virtual environment.

In some embodiments, the speaker 134 may read aloud words, phrases, and/or instructions provided by the user device 126, and the speaker 134 may aid the user in interacting with the user device 126, the electronic device 104, and/or the passive user interface(s) 124. For example, the user may utilize the body or a portion thereof 102, the electronic device 104, and/or the passive user interface(s) 124 to modify the input and/or the output of the speaker 134 of the user device 126 to turn on or off the volume, lower or raise the volume, speak aloud gestures of the user when the user utilizes the electronic device 104, and other applications. In some embodiments, the speaker 134 may read aloud words, phrases, and/or instructions requesting user input during the training of the machine learning model 120.

In some embodiments, the application(s) 136 may be a software application installed on the user device 126 or accessed using the user device 126; a function of the user device 126; a peripheral of the user device 126; or another entity.

In some embodiments, the interface 122 of the reflection coefficient measurement circuitry 110 (and/or the electronic device 104) and the interface 142 of the user device 126 are configured to receive and/or transmit between said entities, for example, by using communication coupling 152. Alternatively, or additionally, the devices may utilize their respective interfaces to communicate with each other indirectly by, for example, using a network (not illustrated in FIG. 1). In some embodiments, each or either of the interfaces may communicate with a server (not illustrated in FIG. 1), for example, via the network. In some embodiments, the interface 122 and/or the interface 142 may include and/or utilize an application programming interface (API) that may interface and/or translate requests across the network to the electronic device 104, the reflection coefficient measurement circuitry 110, and/or the user device 126. The interface 122, the interface 142, and/or the network may support a wired and/or a wireless communication using a variety of communication protocols and/or standards.

Examples of such protocols and standards include: a 3rd Generation Partnership Project (3GPP) Long-Term Evolution (LTE) standard, such as a 4th Generation (4G) or a 5th Generation (5G) cellular standard; an Institute of Electrical and Electronics (IEEE) 602.11 standard, such as IEEE 602.11g, ac, ax, ad, aj, or ay (e.g., Wi-Fi 6® or WiGig®); an IEEE 602.16 standard (e.g., WiMAX®); a Bluetooth Classic® standard; a Bluetooth Low Energy® or BLER standard; an IEEE 602.15.4 standard (e.g., Thread® or ZigBeeR); other protocols and/or standards that may be established and/or maintained by various governmental, industry, and/or academia consortiums, organizations, and/or agencies; and so forth. Therefore, the network may be a cellular network, the Internet, a wide area network (WAN), a local area network (LAN), a wireless LAN (WLAN), a wireless personal-area-network (WPAN), a mesh network, a wireless wide area network (WWAN), a peer-to-peer (P2P) network, and/or a Global Navigation Satellite System (GNSS) (e.g., Global Positioning System (GPS), Galileo, Quasi-Zenith Satellite System (QZSS), BeiDou, GLObal NAvigation Satellite System (GLONASS), Indian Regional Navigation Satellite System (IRNSS), and so forth).

In addition to, or alternatively of, the communications illustrated in FIG. 1, the reflection coefficient measurement circuitry 110, the electronic device 104, and the user device 126 may facilitate other unidirectional, bidirectional, wired, wireless, direct, and/or indirect communications utilizing one or more communication protocols and/or standards. Therefore, FIG. 1 does not necessarily illustrate all communication signals which may be used in various examples.

In some embodiments, as an electromagnetic wave travels from one transmission medium to another, part of the wave passes through to the new medium, and the remainder is reflected back into the original medium due to the impedance mismatch between the two mediums (or two media). Measuring the magnitude and phase of the reflected wave at the transmission interface can assist in comprehending the new medium's impedance characteristics. This technique can be used in electrical engineering to measure the impedance of an antenna. For example, a VNA applies a continuous wave signal with a frequency that varies with time to an antenna being tested, and the VNA analyzes the reflected signals to determine the antenna's impedance as a function of frequency. Similarly, the reflection coefficient measurement circuitry 110 (e.g., the VNA) is utilized to perform this technique to analyze the body or a portion thereof 102 (e.g., a hand) of the user, where the hand signifies, or is configured to act as, an antenna. Consequently, the reflection coefficient measurement circuitry 110 reads or measures the impedance of the hand over a frequency or a range of frequencies.

The body or a portion thereof 102 absorbs electromagnetic waves (e.g., RF waves, signals, RF signals) and permits transmission at specific frequencies, thereby, allowing the hand to act as an RF antenna. The electronic device 104 leverages this phenomenon by injecting a small RF signal into body or a portion thereof 102 through its contact (e.g., coupling or contact 146) with the finger and capturing the reflected signal to measure the impedance of the body or a portion thereof 102. As the body or a portion thereof 102 (e.g., hand, finger) posture changes, the antenna geometry changes, in turn changing the associated impedance. An impedance change may also occur if the body or a portion thereof 102 (e.g., hand, finger) touches exterior surfaces, such as external objects, the passive user interface(s) 124, or a first portion of the body (e.g., a first hand, a first finger, a first finger of the first hand) touches a second portion of the body (e.g., a second hand, a second finger). In some embodiments, the signal injected from the electronic device 104 can flow through the user's body or a portion thereof 102 to the exterior surfaces (or the passive user interface(s) 124), causing the signal to reflect at the newly constructed boundaries between the body or a portion thereof 102 and the surface, and resulting in additional impedance change(s). This change can provide information useful for identifying or recognizing interactions of the body or a portion thereof 102 (e.g., hand, finger) with external surfaces (or the passive user interface(s) 124).

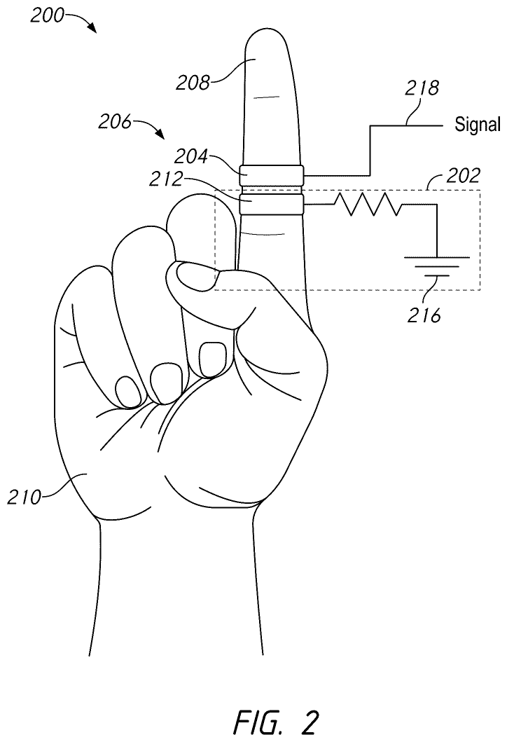

In some embodiments, the electronic device 104 can also perform user identification or authentication. For example, assume a user picks up a ring 206 of FIG. 2 and wears the ring 206 of FIG. 2. The electronic device 104 transmits electromagnetic waves (RF waves) via the signal trace 108 into the body or a portion thereof 102 of FIG. 1 (e.g., finger) of the user wearing the ring 206 of FIG. 2. The electronic device 104 utilizes the reflection coefficient measurement circuitry 110 to measure the reflection coefficient(s) (e.g., S11 parameters) over a range of frequencies of the electromagnetic waves. The electronic device 104 can then measure an absorption pattern of the electromagnetic waves by the body of the user or by a portion of the body (e.g., finger, hand) of the user. Based on a unique, or nearly unique, absorption pattern of the electromagnetic waves, the user is identified as an authorized user or as an unauthorized user of the electronic device 104, the ring 206 of FIG. 2, the user device 126, the application(s) 136 of FIG. 1, another function of the user device 126 (e.g., controls of the display 132, the speaker 134, etc.), or a peripheral of user device 126 (e.g., headphones, headset, etc.).

In some embodiments, if the user is identified as an authorized user, the electronic device 104 and/or the user device 126 grants access to the authorized user to utilize the user device 126, the application(s) 136, a function, or a peripheral thereof. If the user, however, is determined to be an unauthorized user, the electronic device 104 or the user device 126 denies access to the unauthorized user from utilizing the user device 126, the application(s) 136, the function, or the peripheral thereof. Therefore, in some embodiments, the identification or authorization is a binary identification or authorization (e.g., yes or no, one or zero, authorized user or unauthorized user).

In some embodiments, however, the electronic device 104 and/or the user device 126 can determine the identity of an authorized user from multiple authorized users (e.g., Jane Doe working on Floor X of the Building Y of the Company or Entity Z). Assume the electronic device 104 and/or the user device 126 are embedded in a door handle of the Floor X. Jane Doe, an authorized user, can simply place their hand on the door handle, and the electronic device 104 and/or the user device 126 can identify Jane Doe, at least based on the absorption pattern of the electromagnetic waves. For example, the machine learning model 120 may be trained to infer Jane Doe's identity based on reflection coefficient measurements received from the reflection coefficient measurement circuitry 110. Subsequently, the door to the Floor X opens for Jane Doe to enter the Floor X.

With all the advances in humanity, unfortunately, violence still occurs, whether in a distant battlefield or near our homes. The systems, apparatuses, and methods described herein can be used to at least limit, or reduce, un-authorized, unintentional, or random violence by embedding the electronic device 104 into a smart weapon (e.g., the user device 126), where only authorized users (e.g., military, law enforcement, law-abiding and responsible adult) can utilize the smart weapon. As the user holds the smart weapon, the electronic device 104 can determine identification or authentication of the user, one time, continuously, or in time intervals. Should another user (an un-authorized user) at any point get a hold of the smart weapon, the smart weapon will not function. Any of the identification or authentication systems, apparatuses, and methods described herein can be configured to identify or authorize the user, even when the user is in an idle state. For example, the electronic device 104 may be embedded on a handle of the smart weapon. Therefore, the user need not put his index finger on a trigger or a button of the smart weapon for the smart weapon to identify or authenticate the user.

In some embodiments, the user device 126 may include another authentication technology (e.g., a technology that uses a username, a password, a passcode, a personal identification number (PIN), fingerprint sensor, etc.). In such a case, the electronic device 104 can augment or enhance the authentication capabilities of the user device 126 by providing another-factor authentication, for example, one time, continuously, or in time intervals.

In some embodiments, the electronic device 104 can be used to identify domesticated or non-domesticated animals. For example, the electronic device 104 can be embedded in a smart pet door. As an authorized pet (e.g., a cat or a dog belonging to a home) touches the smart pet door, the door opens. As another example, the electronic device 104 can be embedded on a pet's collar, and a smart pet food dispenser (e.g., the user device 126) can only dispense a pre-determined amount of pet food to an authorized pet. For example, this smart food dispenser denies food to other critters (e.g., racoons, foxes, etc.). As another example, this smart food dispenser can be used to limit the number of calories the authorized pet can consume in a time interval.

In some embodiments, a first electronic device (e.g., the electronic device 104) can be embedded on a first glove, and a second electronic device (e.g., the electronic device 104) can be embedded on a second glove. For example, the gesture input recognition supported by the electronic device 104 can enable a hearing impaired and/or mute person to communicate using sign language with another person that does not understand sign language. As another example, the gesture recognition supported by the electronic device 104 can also be used as a virtual keyboard.

FIG. 2 shows a diagram 200 of a biasing circuit 202 and a signal trace 204 embedded in or on a ring 206, in accordance with examples described herein. For the sake of illustration clarity, FIG. 2 does not show all components of the ring 206, but rather the electronic components that help describe FIG. 2 in the context of this disclosure. FIG. 2 is illustrated and described in the context of FIG. 1. To that end, the signal trace 204 of FIG. 2 may be implemented using and/or may be used to implement the same or equivalent to the signal trace 108 of FIG. 1; and the biasing circuit 202 of FIG. 2 may be implemented using and/or may be used to implement the same or equivalent to the biasing circuit 106 of FIG. 1.

In some embodiments, the biasing circuit 202 may include a biasing trace 212 that is coupled to a biasing resistor 214 and is coupled to ground 216. In some embodiments, the biasing resistor 214 may be omitted, and the biasing trace 212 may be directly coupled to ground 216. In some embodiments, ground 216 may be a local ground. In some embodiments, the biasing trace 212 may be coupled to another node having another electric potential (e.g., V_{DD}, V_{CC}, V_{BB}, etc., not illustrated as such). In some embodiments, the biasing circuit 202 may be another circuit.

As is illustrated in FIG. 2, the user has placed the ring 206 on their index finger 208 of their right hand 210. In some embodiments, the ring 206 is adjustable, and the user can place the ring 206 on any of their fingers.

Note that the reflection coefficient measurement circuitry 110 of FIG. 1 (e.g., a VNA, or another device configurable to measure the reflection coefficient) is not illustrated in FIG. 2. Depending on the size (e.g., relatively small) of the reflection coefficient measurement circuitry 110 of FIG. 1, the reflection coefficient measurement circuitry 110 of FIG. 1 can also be embedded in or on the ring 206 of FIG. 2. Alternatively, the reflection coefficient measurement circuitry 110 of FIG. 1 can be embedded in or on another wearable device (e.g., a wristband), and the wristband (not illustrated) can be coupled with the ring 206 of FIG. 2 via, for example, the coupling or transmission line 148 of FIG. 1.

In some embodiments, the electronic device 104 of FIG. 1 uses the ring 206 of FIG. 2 to measure the impedance of the user's hand 210. An impedance change can occur when the user moves their finger 208 and/or holds an object or touches an external surface using their hand 210. By analyzing the change in impedance over time, the ring 206 can be used to detect a gesture the user performs, identify the interactions with the passive user interface(s) 124 of FIG. 1, recognize the object held in the user's hand 210, and/or identify and/or authenticate the users themselves.

In some embodiments, the ring 206 is used to measure impedance by measuring the reflection coefficient, also known as the S11 parameter. The S11 parameter specifies the amount of a wave that is reflected by an impedance discontinuity in the transmission medium. The magnitude component of this measurement can be defined as the ratio of the reflected wave's amplitude to the incident wave's amplitude. An S11 port of the reflection coefficient measurement circuitry 110 of FIG. 1 (or a VNA) can be used to perform this measurement. As illustrated in FIG. 2, the ring 206 may include two electrodes (e.g., the signal trace 204 and the biasing trace 212) for measuring impedance with the VNA. A first electrode (e.g., the signal trace 204) of the ring 206 transmits a signal 218 into the hand 210 and reads the reflected signal 218, while a second electrode (e.g., the biasing trace 212) biases the hand 210 to ground 216 (e.g., a local ground) through the biasing resistor 214 (e.g., a two megaohm (MΩ) biasing resistor).

In some embodiments, each of the signal trace 204 and the biasing trace 212 may be an exposed copper region on a flexible printed circuit board (PCB) built on a polyimide sheet. The flexible PCB allows the signal trace 204 and biasing trace 212 to wrap conformally around the user's finger 208 within the ring 206. Both traces (or electrodes) can be placed adjacent to one another along their entire length, with a gap between them (e.g., 2-5 millimeter (mm) gap). To prevent skin and environmental moisture from causing oxidization, the traces can be coated with a conductive material that resists or lowers oxidation (e.g., gold, platinum). In some embodiments, the flexible PCB of the ring 206 is coupled to the reflection coefficient measurement circuitry 110 of FIG. 1 (e.g., a VNA) via a U.FL connector. In some embodiments, the flexible PCB is affixed to a hook-and-loop strip with double-sided tape, thereby, allowing the signal trace 204 and the ring 206 to be wrapped around fingers of varying sizes.

In an example embodiment, the S11 parameter is measured using a small-sized VNA. The VNA can be powered using a rechargeable battery (e.g., the power supply 112 of FIG. 1), and the VNA can support one or more frequency ranges. The VNA can draw a relatively small amount of power (e.g., 1-2.4 Watts (W)). To ensure safety for humans (or animals) the VNA is configurable to have a maximum output power. For example, a 5 dBm output power is considered to be safe for humans. The VNA can be secured on the user's wrist using a hook-and-loop strap to maintain a short connection between the ring 206 and the S11 port of the VNA. Each S11 parameter measurement is made by transmitting a sweep of signal (or electromagnetic waves) frequencies between a pre-determined start and end frequency and measuring the reflected signal for this sweep. The VNA can be configured to record this response as, for example, a 51 data point array and perform 30 sweeps per second, thus, setting the sample rate of 30 Hz. The user application can selectively determine the start and end frequencies. The data can then be transmitted via the communication coupling 152 of FIG. 1 to the user device 126 of FIG. 1.

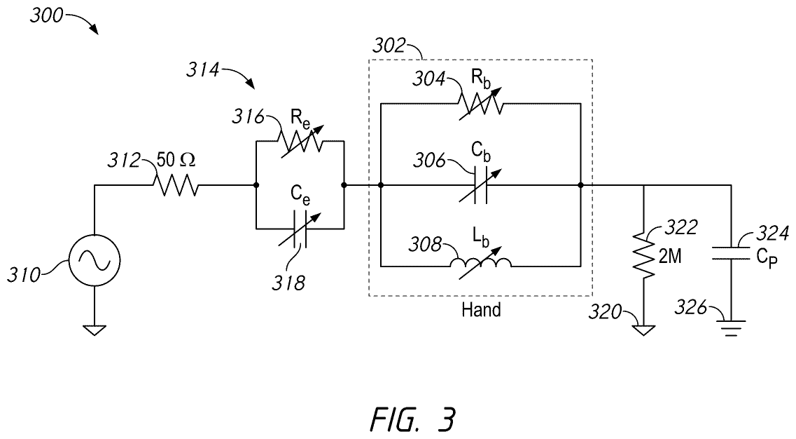

FIG. 3 shows an electrical model 300 of aspects of the electronic device 104 of FIG. 1, the body or a portion thereof 102 of FIG. 1, and the ring 206 of FIG. 2, in accordance with examples described herein. FIG. 3 is illustrated and described in the context of FIG. 1 and FIG. 2.

In some embodiments, the electrical model 300 includes or models a hand 302, a variable resistor 304, a variable capacitor 306, a variable inductor 308, an AC signal 310, a coupling or transmission line 312, an impedance mismatch 314, a resistance mismatch 316, a capacitance mismatch 318, a local ground 320, a biasing resistor 322, an earth ground 326, and a parasitic capacitance 324. In some embodiments, the electrical model 300 may include fewer or more components than what are shown in FIG. 3.

In some embodiments, the hand 302 can be modeled as a lumped combination of the variable resistor 304 (R_{b}), the variable capacitor 306 (C_{b}), and the variable inductor 308 (L_{b}). The values of the variable resistor 304, the variable capacitor 306, and/or the variable capacitor 306 are based on the hand 302's posture and/or what the hand 302 is touching (e.g., touching an external object).

In some embodiments, the reflection coefficient measurement circuitry 110 of FIG. 1 feeds the AC signal 310 of FIG. 3 (e.g., electromagnetic waves) through the coupling or transmission line 312 of FIG. 3 (e.g., a 50 Ω transmission line). Due to a ring-skin interface's impedance mismatch, part of the AC signal 310 reflects back, and the rest of the AC signal 310 propagates to the hand 302, thereby, causing the impedance mismatch 314. The electrical model 300 models the impedance mismatch 314 as the resistance mismatch 316 (Rₑ) and the capacitance mismatch 318 (Cₑ). In some embodiments, the resistance mismatch 316 (Rₑ) depends on factors like skin moisture; and the capacitance mismatch 318 (Cₑ) is determined by other variables, for example, by how tightly the electrodes (e.g., the signal trace 204 and the biasing trace 212 of the ring 206 of FIG. 2) are in contact with the skin.

The hand 302 is also coupled to the sensor's local ground 320 through a biasing resistor 322 (e.g., a 2 MΩ resistor). The parasitic capacitance 324 (Cₚ) represents a parasitic capacitance as the body of the user is coupled to the earth ground 326, such as when the user is standing on the ground. Factors like the material and thickness of the user's shoe soles and the count of feet in contact with the floor may affect the parasitic capacitance 324 (Cₚ). In some embodiments, the parasitic capacitance 324 (Cₚ) is relatively small due to the weak coupling with the earth ground 326. In such a case, the impedance of the hand 302 may be the main impedance of the electrical model 300.

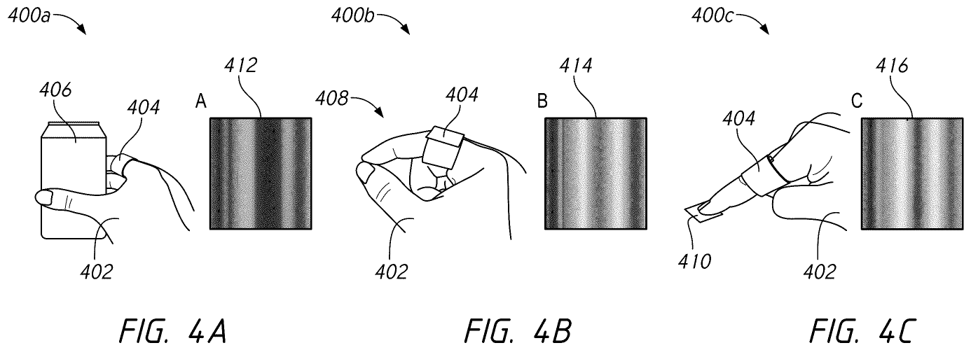

FIG. 4A shows a hand 402 of a user wearing a ring 404, and the user is holding an object 406 (an external object). FIG. 4B shows the hand 402 of the user wearing the ring 404, and the user is performing a one-handed gesture 408. FIG. 4C shows the hand 402 of the user wearing the ring 404, and the user is touching a passive user interface 410.

FIG. 4A, FIG. 4B, and FIG. 4C are illustrated in the context of FIG. 1, FIG. 2, and FIG. 3. For example, the ring 404 of FIG. 4A, FIG. 4B, and FIG. 4C is the same as, or equivalent to, the ring 206 of FIG. 2.

By analyzing impedance over time and frequency, shown in spectrogram 412, spectrogram 414, and spectrogram 416, these impedance changes can be used for the object identification or recognition of FIG. 4A, the gesture input recognition of FIG. 4B, and the interaction with the passive user interface of FIG. 4C, respectively.

For example, the spectrograms 412, 414, and 416 may be generated by the reflection coefficient measurement circuitry 110 of FIG. 1 in some examples, as the user performs the actions shown in FIG. 4 (e.g., holding an object, performing a gesture, and/or touching a passive user interface.). The machine learning model 120 may be trained to infer, based on the received spectrogram, that the user is holding a particular object, performing a particular gesture, and/or touching a particular portion of a user interface.

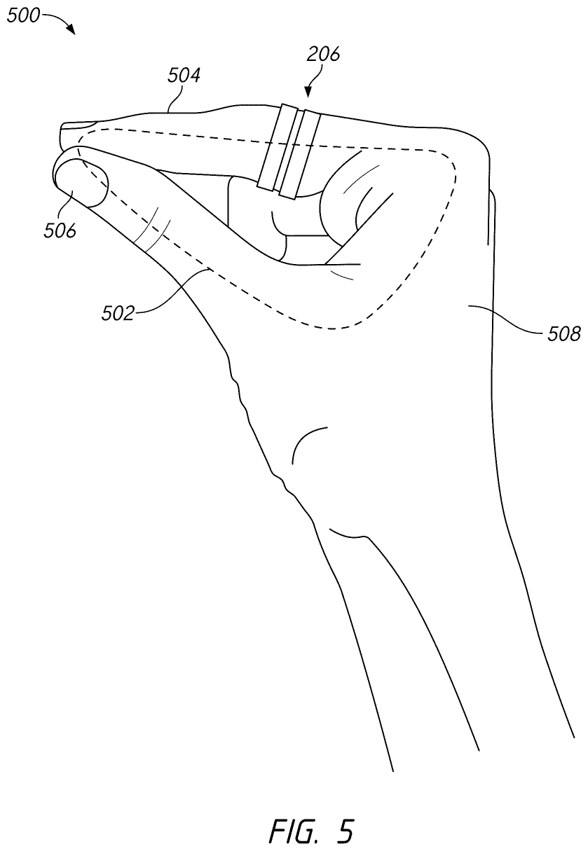

FIG. 5 shows a diagram 500 of an electrical path 502, where the user wearing the ring 206 of FIG. 2 performs one-handed gestures, in accordance with examples described herein. Specifically, the electrical path 502 is a loop completed between the index finger 504 of a hand 508 touches the thumb 506 of the same hand 508. Variations in this electrical path may vary the electrical parameters determined by the ring. For example, the reflection coefficient measurement circuitry 110 may measure different S11 parameters as the electrical path is varied through the use of multiple gestures. The machine learning model 120 may be trained to infer the identify of a particular gesture based on the reflection coefficient measurements.

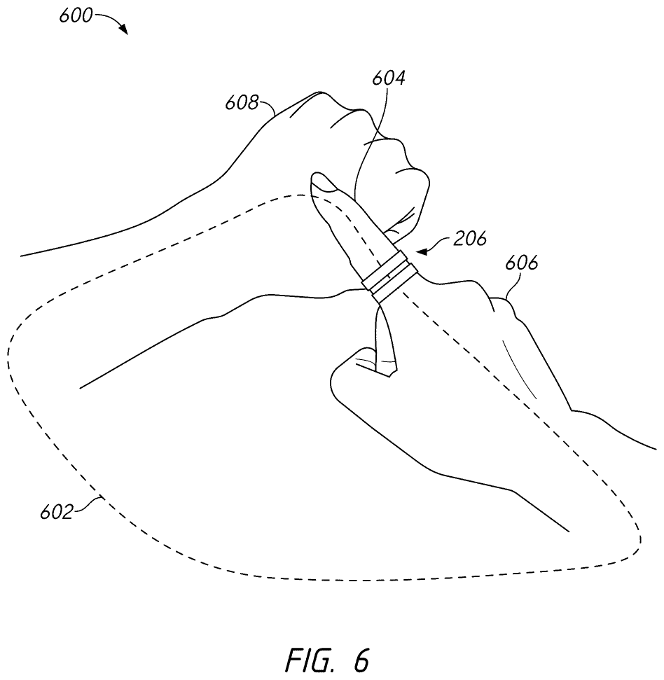

FIG. 6 shows a diagram 600 of an electrical path 602, where the user wearing the ring 206 of FIG. 2 performs two-handed gestures, in accordance with examples described herein. Specifically, the electrical path 602 is a loop completed when the index finger 604 of a hand 606 touches the back of the other hand 608. In such a case, the electrical path 602 goes through the torso of the user. Variations in this electrical path may vary the electrical parameters determined by the ring. For example, the reflection coefficient measurement circuitry 110 may measure different S11 parameters as the electrical path is varied through the use of multiple gestures. The machine learning model 120 may be trained to infer the identify of a particular gesture based on the reflection coefficient measurements.

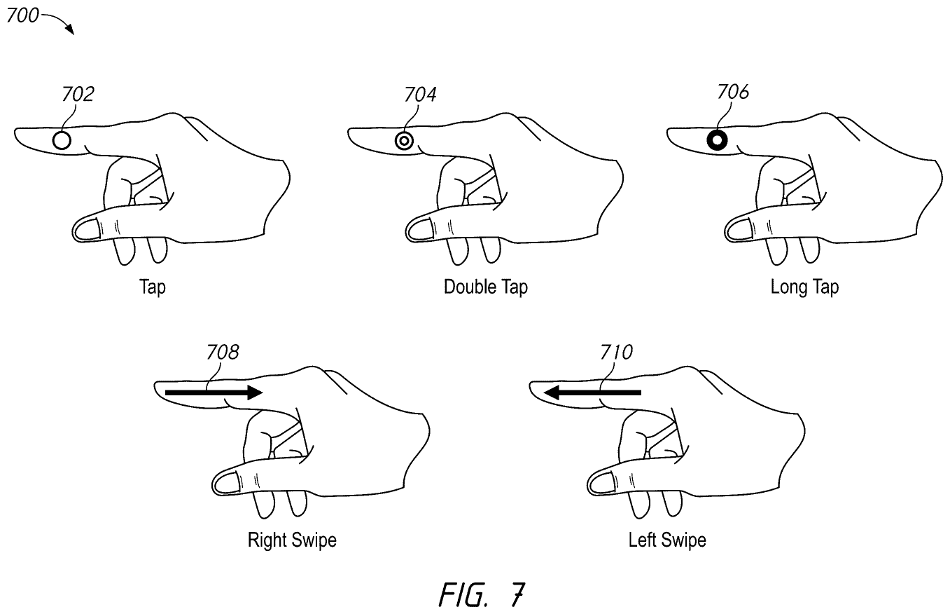

FIG. 7 shows an environment 700 of various one-handed gestures, in accordance with examples described herein. The various one-handed gestures include a tap 702, illustrated with a circle having a first line width; a double tap 704, illustrated with two co-centric circles; a long tap 706, illustrated with a circle having a second line width, where the second line width is thicker than the first line width; a right swipe 708, illustrated with an arrow pointing from left to right; and a left swipe 710, illustrated with an arrow pointing from right to left.

In some embodiments, the user can perform these gestures using their index finger while wearing the ring 206 of FIG. 2. For example, the different taps are made close to the index finger's tip, while the swipes are made between the tip and past the middle of the index finger.

In some embodiments, the various taps support different selection possibilities in an application (e.g., application(s) 136 of FIG. 1) of a user device (e.g., user device 126 of FIG. 1). In some embodiments, the swipes (e.g., right swipe 708, left swipe 710) enable navigation of an application of the user device. The different gestures may be distinguished, for example, using the machine learning model 120 of FIG. 1. The different gestures may generate different reflection coefficient measurements and/or patterns of reflection coefficient measurements. The inference to a particular gesture by the machine learning model 120 may cause different actions to happen based on the performance of the gesture.

For example, the user device may be a VR/AR headset, and the user can interact with the VR/AR headset using one-handed gesture. The tap 702 may perform a first action; the double tap 704 may perform a second action; and the long tap 706 may perform a third action using the VR/AR headset. As another example, the right swipe 708 may swipe right an image displayed in the VR/AR headset; and the left swipe 710 may swipe left the image displayed in the VR/AR headset. Some existing technologies (e.g., prior art) may use camera(s) to enable the user to interact with the VR/AR headset. These existing technologies, however, require that the hand of the user be in a line-of-sight (LOS) with the camera(s) of the VR/AR headset. This may be disadvantageous for certain tasks, or may be awkward to the user, because the hand may become part of the image displayed in the VR/AR headset. By contrast, using the electronic device 104 of FIG. 1 (e.g., the reflection coefficient measurement circuitry 110 of FIG. 1 and the ring 206 of FIG. 2), the hand of the user need not be in a LOS with the camera(s) of the VR/AR headset. The user, however, can still use their hand to interact with the VR/AR headset in a more advantageous or natural manner.

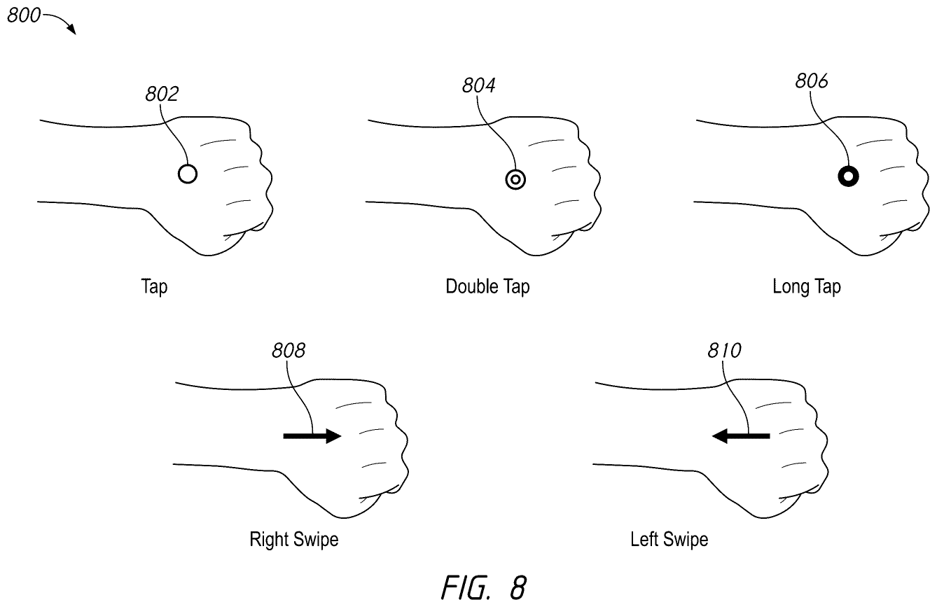

FIG. 8 shows an environment 800 of various two-handed gestures, in accordance with examples described herein. The user makes the two-handed gesture with the index finger (not illustrated in FIG. 8) of the hand (not illustrated in FIG. 8) carrying the ring (not illustrated in FIG. 8) on the back of the other hand, as is illustrated in FIG. 8. As is illustrated in FIG. 8, the various taps are made close to the back of the other hand's center, and the swipes cover most of said hand back's length. For clarity, FIG. 8 illustrates the back of the other hand. Therefore, the hand with the index finger and the ring on that index finger is not illustrated in FIG. 8.

The various two-handed gestures include a tap 802 on the back of the other hand, illustrated with a circle having a first line width; a double tap 804 on the back of the other hand, illustrated with two co-centric circles; a long tap 806 on the back of the other hand, illustrated with a circle having a second line width, where the second line width is thicker than the first line width; a right swipe 808 on the back of the other hand, illustrated with an arrow pointing from left to right; and a left swipe 810 on the back of the other hand, illustrated with an arrow pointing from right to left.

In some embodiments, gesture recognition (e.g., one-handed gesture, two-handed gesture) can be built upon the frequency domain and temporal pattern generated in the S11 parameter measurements made while performing the gestures. Changes in the frequency domain may occur due to new propagation paths for the transmit signal while performing the gesture. FIG. 5 and FIG. 6 show the signal paths generated when the user performs one-handed and two-handed gestures, respectively. Temporal patterns (not illustrated in FIG. 8) result from finger motions needed to complete the gesture. For instance, the time-varying movement of a double tap differs from that of a single tap, and so forth.

In some embodiments, the S11 parameter measurements for gesture recognition can be taken using a frequency range sweep of, for example, 1 MHz to 1 GHz. A gesture recognition pipeline may begin by applying a moving median filter to the live S11 parameter data stream with a sliding window of, for example, 200 milliseconds (ms). This can emphasize impedance changes, while attenuating the noise generated by motion artifacts. Then, an example 1.5-second window of S11 parameter data (e.g., approximately 45 S11 parameter samples at 30 Hz) can be individually processed to detect whether a gesture was performed. The S11 parameter samples in each window can be vertically stacked to produce a spectrogram (not illustrated). The spectrogram can then be resized and fed into the machine learning model 120 of FIG. 1 to identify or recognize the gesture.

In some embodiments, since the gesture can occur within the example 1.5-second window, synthetic data can be produced by moving this window in time between, for example, −600 and 600 milliseconds (ms) in increments of 30 ms and append it to the original data when training the machine learning model 120 of FIG. 1. The time shifting can be accomplished by rolling the spectrogram along the time axis, while wrapping around the edges.

As stated, the machine learning model 120 of FIG. 1 can be a user-dependent model or a user-independent model. For the user-independent model, the training of the machine learning model 120 of FIG. 1 can be augmented or supplemented by generating data from rolling the spectrograms along the frequency axis, because each person's unique hand anatomy results in impedance responses in different frequency bands. By rolling the spectrograms in this manner, the machine learning model 120 can learn patterns across the whole frequency domain. Subsequently, the machine learning model 120 may be able to generalize. Therefore, for user-independent models, the training set is augmented, both, in the time and frequency domains.

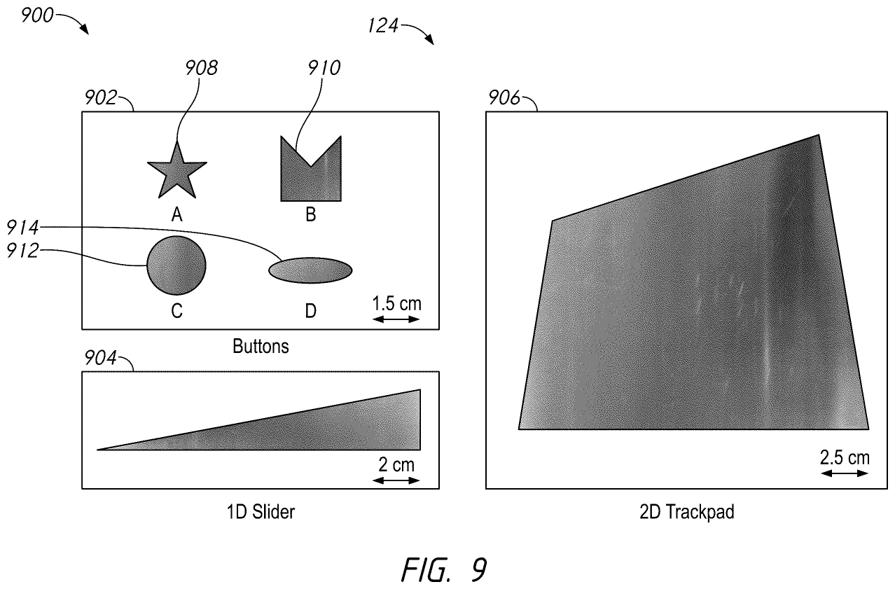

FIG. 9 shows an environment 900 of various passive user interface(s) 124, in accordance with examples described herein. Specifically, passive user interface(s) 124 include buttons 902, a 1D slider 904, and a 2D trackpad 906. The buttons 902 include a star 908, a polygon 910, a circle 912, and an ellipse 914. It is to be understood that the passive user interface(s) 124 may include fewer or more passive user interfaces than shown, or other designs of passive user interfaces.

In some embodiments, the electronic device 104 of FIG. 1 (e.g., the ring 206 of FIG. 2 and the reflection coefficient measurement circuitry 110 of FIG. 1) provides a method for measuring surface impedance by touch. With that in mind, each of the passive user interface(s) 124 offers a unique, or nearly unique, characteristic impedance. The electronic device 104 of FIG. 1 can identify the touch and interaction with these passive user interfaces based on their different impedance signatures.

In some embodiments, the reflection coefficient measurement circuitry 110 of the electronic device 104 of FIG. 1 (e.g., the VNA) can be configured to transmit electromagnetic waves to a body or a portion thereof 102 of FIG. 1 (e.g., the finger 208 of FIG. 2) via the signal trace 108 of FIG. 1 (or the signal trace 204 of the ring 206 of FIG. 2). The reflection coefficient measurement circuitry 110 of FIG. 1 can then measure a reflection coefficient (e.g., S11 parameter). Based on the reflection coefficient, the electronic device 104 or the user device 126 of FIG. 1 can identify or recognize a user's touch of at least one of the passive user interface(s) 124.

In some embodiments, the passive user interface(s) 124 can be constructed using an electrically conductive material, such as a thin copper sheet. Copper is an excellent electrical conductor, relatively inexpensive, and offers a significant impedance change when touched with a body or a portion thereof 102 that is configured to utilized with the electronic device 104. Since impedance is dependent on the shape and size of the passive user interface, varying the shape and size of each of the passive user interface(s) 124 can create distinct impedance signatures across frequency.

For example, each of the buttons 902 has a unique shape (e.g., star 908, polygon 910, circle 912, ellipse 914) to ensure that each of the buttons 902 has a distinct impedance profile. As another example, the 1D slider 904 is asymmetrical along the direction of sliding (e.g., left to right, or right to left) to generate a continuously varying impedance change, which helps determine where the finger is on the slider. As yet another example, the geometry of the 2D trackpad 906 is asymmetric in two directions (e.g., x- and y-direction) so that each trackpad location offers a distinct impedance profile.

In some embodiments, to recognize a button of any of the buttons 902 using the electronic device 104, the machine learning model 120 may employ a support vector machine classifier (e.g., kernel=rbf). The classifier of the machine learning model 120 can take the example 51-point S11 parameter measurement as a feature vector; predict whether any button of the buttons 902 is touched; and identify which button of the buttons 902 is touched. In some embodiments, the classifier of the machine learning model 120 can be trained on data collected, while each button is touched, and while no button is touched (e.g., null data).

In some embodiments, to predict the finger location on the 1D slider 904 and/or the 2D trackpad 906, the machine learning model 120 may employ a random forest regressor for each (e.g., independently) of the 1D slider 904 and the 2D trackpad 906. The regressor of the machine learning model 120 receives S11 parameter measurements (e.g., 51-point gesture vector length) from discrete locations on the interface as training data and predicts a continuous output (e.g., x for the 1D slider 904, and x and y for the 2D trackpad 906).

In some embodiments, the machine learning model 120 that is used to evaluate the user's interactions with the passive user interface(s) 124 may be a user-dependent model, a user-independent model, or a combination thereof. For example, the user may initially start using a user-independent model (e.g., a model that is pre-trained, a generalized model). The user can then increase the accuracy of the model by training the machine learning model 120 to fit their own needs, thereby, the machine learning model 120 may later become a user-dependent model.

The passive user interface(s) 124 can be pre-embedded in or on a device at a factory, or the user can embed them where they desire. In some embodiments, passive user interface(s) 124 can be embedded on a desk, coffee table, light switch or near a light switch, on the door of a fridge, or other devices and/or appliances. For example, assume the user opens the door of a fridge with electronic capabilities (e.g., a smart fridge), and the user may notice that they are out of milk. The star 908 that can be embedded (e.g., as a refrigerator magnet) on the door of the fridge can be configured so when the user touches the star 908, a carton of milk is added to a shopping list. In some embodiments, the shopping list may be an application(s) 136 of the user device 126 of FIG. 1.

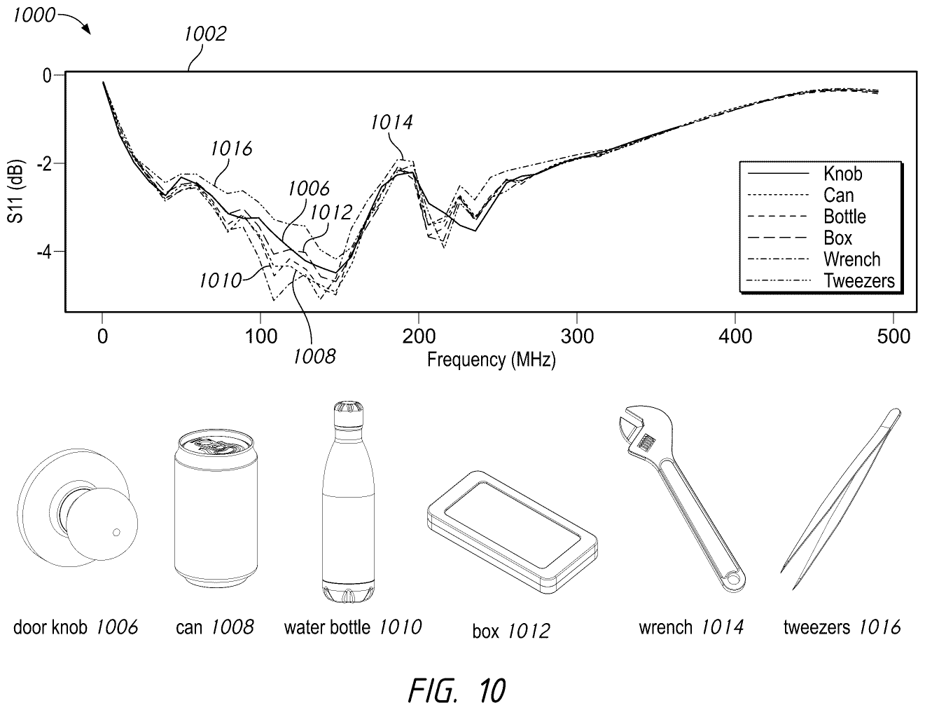

FIG. 10 shows a graph of reflection coefficients of various objects, where the reflection coefficients are measured over a range of frequencies, in accordance with examples described herein. The graph shows a relation of S11 parameters 1002 versus frequency 1004, where the S11 parameters 1002 are expressed in decibels (dB), and the frequency 1004 is expressed in megahertz (MHz). The various objects (e.g., exterior objects) may include a door knob 1006, a can 1008, a water bottle 1010, a box 1012, a wrench 1014, tweezers 1016, or other objects. The objects can be electrically conductive objects (e.g., having a metallic composition), non-metallic objects (e.g., paper, glass), or objects with water content (e.g., fruit, vegetables), electrically passive (as illustrated in FIG. 10), electrically active (not illustrated), or combinations thereof.

In some embodiments, the machine learning model 120 of FIG. 1 includes an SVM classifier (e.g., kernel equals a polynomial) to classify objects using, for example, a 51-length S11 parameter measurement as the feature vector. In some embodiments, the start frequency may be set at 1 MHz, and the end frequency may be set at 500 MHZ, since most dynamic changes observed in the graph of FIG. 10 are in this frequency band. It is to be understood, however, that the electronic device 104 can be configured to use other frequencies.

In some embodiments, the electronic device 104 of FIG. 1 (e.g., the reflection coefficient measurement circuitry 110 of FIG. 1 coupled to the ring 206 of FIG. 2) can detect objects as the user touches said objects. Therefore, the electronic device 104 can provide a contextually aware input modality.

In some embodiments, in addition to, or alternatively of, the S11 parameter 1002 data gleaned from holding the objects, null gesture data (not illustrated) may was also be included and/or analyzed. The null gestures may include users interacting with their phones or desk, sitting, standing, coming their hair, driving, or performing any other action (except for the pre-defined one-handed gestures or two-handed gestures).

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

What is claimed is:

1. An electronic device comprising:
reflection coefficient measurement circuitry;
a signal trace configured to be coupled between said reflection coefficient measurement circuitry and a portion of a body, wherein said reflection coefficient measurement circuitry is configured to:
transmit electromagnetic waves into said portion of the body using said signal trace; and
measure a reflection coefficient over a range of frequencies of said electromagnetic waves; and
a processor configured to determine, based on said reflection coefficient, a position of said portion of the body, a motion of said portion of the body, a touch of an exterior object with the portion of the body, or combinations thereof.

2. The electronic device of claim 1, wherein said signal trace is configured to carry a transmitted signal from said reflection coefficient measurement circuitry to said portion of the body, and a reflected signal from said portion of the body to the reflection coefficient measurement circuitry.

3. The electronic device of claim 2 further comprising a biasing circuit for biasing said portion of the body.

4. The electronic device of claim 3, wherein:
said biasing circuit comprising a biasing resistor coupled between a biasing trace and ground; and
said biasing trace is configured to be coupled to said portion of the body.

5. The electronic device of claim 1, wherein said position and said motion cause a geometrical change of said portion of the body, and wherein said geometrical change causes an impedance change of said portion of the body.

6. The electronic device of claim 1, wherein said reflection coefficient measurement circuitry comprises a vector network analyzer (VNA) configured to measure at least one scattering parameter (S-parameter).

7. The electronic device of claim 6, wherein said at least one S-parameter comprises an S11 parameter, and wherein said signal trace is coupled with said portion of the body at a contact point.

8. The electronic device of claim 1, wherein said range of frequencies comprise frequencies between one megahertz (MHz) and one gigahertz (GHz), 50 kilohertz (kHz) and six GHz, or another range of frequencies.

9. The electronic device of claim 1, wherein said signal trace is embedded in or on a ring, a glove, a wristband, a headband, or a headset.

10. The electronic device of claim 1, wherein said processor is further configured to utilize a machine learning model, wherein said machine learning model is configured to identify a gesture of a user, a passive interface input, said exterior object, a user identification or authentication, or combinations thereof.

11. A method for identifying or authenticating a user, said method comprising:
transmitting, via a signal trace, electromagnetic waves into a portion of a body of said user;
measuring, using a reflection coefficient measurement circuitry, a reflection coefficient over a range of frequencies of said electromagnetic waves;
measuring an absorption pattern of said electromagnetic waves by said body or said portion of the body of said user; and
identifying or authenticating said user based on a unique or a nearly unique absorption pattern of said electromagnetic waves.

12. The method of claim 11, wherein said identification of said user comprises identifying said user, using a machine learning model, as an authorized user or as an unauthorized user of a user device, an application, a function, or a peripheral thereof.

13. The method of claim 12, wherein said method further comprising:
granting access to said authorized user to utilize said user device, said application, said function, or said peripheral thereof; or
denying access to said unauthorized user from utilizing said user device, said application, said function, or said peripheral thereof.

14. The method of claim 11, wherein said user comprises an authorized user of a plurality of authorized users of a user device, an application, a function, or a peripheral thereof, and wherein said identification or said authentication comprises differentiating or recognizing identities between said plurality of authorized users.

15. The method of claim 11, wherein:
said user utilizes an electronic device with said signal trace and said reflection coefficient measurement circuitry; and
said identification or authentication comprises a continuous or time interval identification or authentication of said user.

16. The method of claim 15, wherein:
said electronic device comprises a wearable electronic device; and
said continuous or time interval identification or authentication comprises a first-factor authentication of a plurality-factor authentications.

17. The method of claim 11, further comprises measuring an absorption pattern of said electromagnetic waves due to a position of said portion of the body, a motion of said portion of the body, a touch of an exterior object with said portion of the body, a touch of a passive interface with said portion of the body, or combinations thereof.

18. An interface system of a user device, the system comprises:
a processor;
reflection coefficient measurement circuitry;
a signal trace, wherein said signal trace is coupled between said reflection coefficient measurement circuitry and a portion of a body of a user;
one or more electrically passive user interfaces, wherein each of the one or more electrically passive user interfaces comprises one or more electrically-conductive materials; and
a computer-readable storage medium, said computer-readable storage medium having instructions that when executed by said processor, cause said processor to:
transmit electromagnetic waves from said reflection coefficient measurement circuitry to a portion of a body of the user via said signal trace;
measure a reflection coefficient of said electromagnetic waves using said reflection coefficient measurement circuitry; and
identify a user touch of the one or more electrically passive user interfaces based on said reflection coefficient.

19. The system of claim 18, wherein the one or more electrically passive user interfaces further comprise one or more buttons, one or more sliders, one or more trackpads, or combinations thereof.

20. The system of claim 18, wherein said identification of said user touch causes an action of a plurality of pre-determined actions supported by said user device, an application, a function, or a peripheral thereof.
